(19) United States
(12) Patent Application Publication
(10) Pub. No.: US 2025/0190009 A1
(43) Pub. Date: Jun. 12, 2025

(54) SYSTEM AND METHOD FOR SYNCHRONIZING BY MEANS OF READ ACCESS

(71) Applicant: Robert Bosch GmbH, Stuttgart (DE)

(72) Inventors: David Slogsnat, Tuebingen (DE); Martin Maschmann, Reutlingen (DE)

(21) Appl. No.: 18/953,687

(22) Filed: Nov. 20, 2024

(30) Foreign Application Priority Data
Dec. 6, 2023 (DE) 10 2023 212 276.6

(51) Int. Cl. G06F 1/12

(52) U.S. Cl. CPC G06F 1/12

(57) ABSTRACT

A system and to a method for synchronizing the system by means of read command transactions. The method includes receiving, in a second subsystem of the system, a plurality of read command transactions via an interface between a first subsystem and the second subsystem of the system. The second subsystem is configured to synchronize the first subsystem and the second subsystem based on the plurality of read command transactions. This makes simple synchronization possible without the need for any hardware.

### FIELD

The present invention relates to a system and a method for synchronizing by means of read access, in particular when reading sensor data via an interface between sensors and/or between sensors and a host.

### BACKGROUND INFORMATION

Data acquired by one or more sensors can be read according to common standards, such as the I2C standard, the 13C standard, or the SPI standard (serial peripheral interface, SPI). These sensor data may, for example, be read block by block from a memory of a sensor. In order to avoid a loss of sensor data, as described by way of example with reference to FIG. 3, it may be advantageous to read the sensor data before they are overwritten.

The sensor data may also be read directly as a sample, for example after each measurement, for example by means of a corresponding sensor interrupt triggering. This may be advantageous if sensor data must be available and/or processed quickly or substantially in real time, for example due to an application that requires low latency.

However, the clock frequencies of a host and/or of one or more sensors may be different. The host and/or the one or more sensors may, for example, operate with different internally generated clock frequencies. The clock frequencies may vary during operation depending on an operating temperature of the corresponding sensor. The operating temperature of the different sensors may be different and/or may vary differently during operation.

When reading the sensor data, it may therefore be necessary to synchronize the reading of the sensor data with the acquisition of sensor data in order to make optimal use of the available sensor data possible.

Conventional methods and systems for synchronizing sensors may use signals transmitted via dedicated lines between a host and/or one or more sensors. Protocols according to the I2C and I3C standards, for example, support synchronization via a two-pin serial interface.

German Patent Application No. DE 10 2012 203 968 A1 describes a sensor for recording measured values and outputting data samples, with at least a first register for storing a sensor time, which contains time information about the phase position and/or period of the data samples, wherein the first register can be read externally. The sensor includes at least a second register, which can be written externally and through which the phase position and/or the period of the data samples in the sensor can be set.

However, such implementations can be very complex and thus also costly. It would therefore be desirable to provide a system that makes simplified synchronization of the reading of sensor data by a host and/or by one or more sensors possible.

### SUMMARY

The present invention provides a method and a system for synchronizing by means of read access.

Preferred example embodiments of the present invention are disclosed herein.

According to a first aspect, the present invention relates to a method for synchronizing a system by means of read command transactions. According to an example embodiment of the present invention, the method comprises receiving, in a second subsystem of the system, a plurality of read command transactions via an interface between a first subsystem and the second subsystem of the system. The second subsystem is configured to synchronize the first subsystem and the second subsystem based on the plurality of read command transactions. This makes simple synchronization possible without the need for any hardware.

According to a development of the present invention, the method comprises determining a read period of the interface that has elapsed between two read command transactions, in order to calculate a waiting time between the end of a sampling phase and the start of a directly subsequent sampling phase of the second subsystem.

According to a development of the present invention, the method comprises determining an average value of a plurality of read periods of the interface that have elapsed between two read command transactions, in order to calculate a waiting time between the end of a sampling phase and the start of a directly subsequent sampling phase of the second subsystem.

According to a development of the present invention, the method comprises resetting a counter configured to count up to a threshold value N until a sampling period expires, so that the waiting time corresponds to a difference between the read period and the sampling phase.

According to a development of the present invention, the method comprises resetting a counter configured to count from 1 to a threshold value N until a sampling period expires, so that the waiting time corresponds to a difference between an average value of the read period and the sampling phase.

According to a development of the present invention, the method comprises adjusting a clock generator of the second subsystem based on the plurality of read command transactions.

According to a development of the present invention, the method comprises adjusting a time between an expiration of the sampling phase and a beginning of a next read command transaction.

According to a first aspect, the present invention relates to a system comprising means for receiving, in a second subsystem of the system, a plurality of read command transactions via an interface between a first subsystem and the second subsystem of the system, wherein the second subsystem is configured to synchronize the first subsystem and the second subsystem based on the plurality of read command transactions.

According to a development of the present invention, the system comprises means configured to perform the method as described above.

According to a development of the present invention, the first subsystem is a sensor, which preferably comprises an inertial measurement unit, and the second subsystem is a sensor, which preferably comprises a magnetometer.

### BRIEF DESCRIPTION OF THE DRAWINGS

FIG. 1 is a schematic representation of an exemplary system according to an example embodiment of the present invention with two sensors and a host, which is configured to synchronize reading of sensor data between the sensors and/or the host and at least one of the sensors.

FIG. 2 is a schematic representation of an exemplary structure according to an example embodiment of the present invention with two integrated sensors, which is configured to synchronize reading of sensor data.

FIG. 3 is a schematic representation of a conventional unsynchronized process of reading sensor data via an interface with loss of a sample during reading.

FIG. 4 is a schematic representation of an exemplary synchronized process of reading sensor data via an interface according to an example embodiment of the present invention.

FIG. 5 is a schematic representation of an exemplary method for synchronizing reading of sensor data via an interface according to an example embodiment of the present invention.

In all figures, identical or functionally identical elements and systems are provided with the same reference signs. The numbering of method steps serves the purpose of clarity and is generally not intended to imply a specific chronological order. In particular, a plurality of method steps may also be carried out simultaneously.

### DETAILED DESCRIPTION OF EXAMPLE EMBODIMENTS

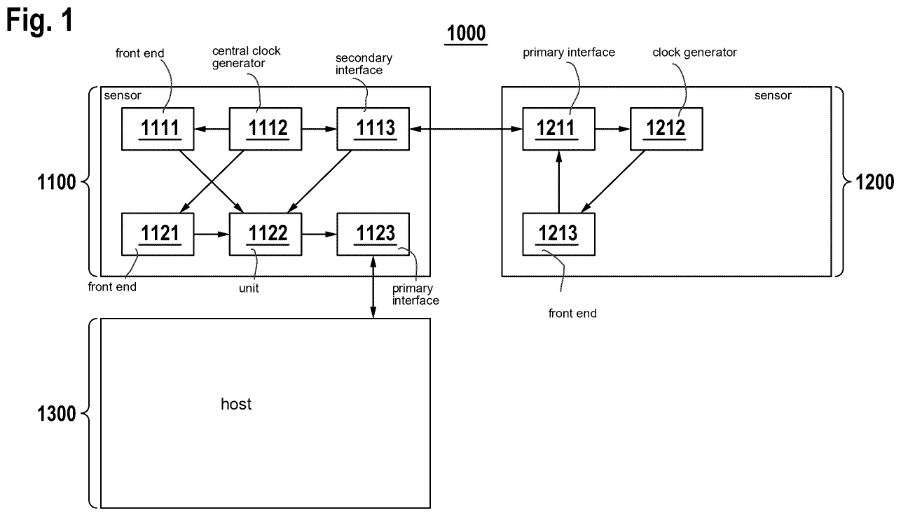

FIG. 1 is a schematic representation of an exemplary system 1000 according to an embodiment with two sensors 1100 and 1200 and a host 1200, which is configured to synchronize reading of sensor data between the sensors 1100 and 1200 and/or the host 1300 and at least one of the sensors 1100 and 1200. The system may also comprise only the two sensors 1100 and 1200 or only one of the sensors 1100 and 1200 and the host 1300.

The sensor 1100 may, for example, be an inertial measurement unit. The sensor 1200 may, for example, be a magnetometer.

The sensor 1100 may, for example, comprise a front end 1111 to an acceleration sensor and a front end 1121 to a gyroscope. Both front ends 1111 and 1121 may receive clock signals from a single, central clock generator 1112 of the sensor 1100. The acceleration sensor and the gyroscope (not shown) may be implemented without their own clock generator. In other words, the acceleration sensor and the gyroscope may be automatically synchronously clocked.

The clock generator 1112 may be configured to determine a sampling rate, according to which sensor data in the form of samples are acquired by the sensor 1100, for example via the front ends 1111 and 1121. The clock generator 1112 may be coupled to a secondary interface 1113 of the sensor 1100.

The secondary interface 1113 may be configured to synchronize sensors, for example the sensor 1200, by means of read access, as described in detail below. The secondary interface 1113 may be coupled to a primary interface 1211 of the sensor 1200. The secondary interface 1113 may be coupled to a unit 1122 for fusing sensor data.

The unit 1122 for fusing sensor data may be coupled to the front ends 1111 and 1121 and may optionally be contained in the sensor 1100. The unit 1122 for fusing sensor data may be coupled to a primary interface 1121.

As an alternative or in addition to the secondary interface 1113 of the sensor 1100, the primary interface 1123 may be configured to synchronize sensors, for example the sensor 1200, by means of read access. The primary interface 1123 may be coupled to a host 1300. As an alternative or in addition to the secondary interface 1113 of the sensor 1100 and/or to the primary interface 1113 of the sensor 1100, the host may be configured to synchronize sensors, for example the sensor 1100 and/or the sensor 1200.

The sensor 1200 may comprise its own clock generator 1212, which may be used to operate the sensor 1200 and to acquire the sensor data. The clock generator 1212 may be used to synchronize the sensor 1200 by means of read access via the primary interface 1211 of the sensor 1200. The clock generator 1212 may be configured to determine a sampling rate, according to which sensor data in the form of samples are acquired by the sensor 1200. The clock generator 1212 may be coupled to the primary interface 1211. The clock generator 1212 may be coupled to a front end 1213 of a magnetometer. The front end 1213 may be coupled to the primary interface 1211.

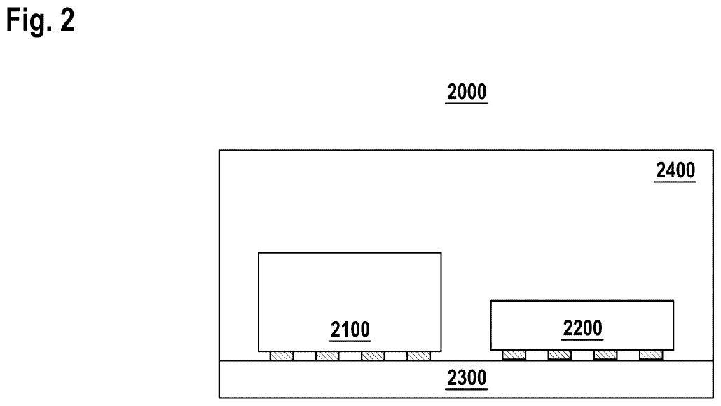

FIG. 2 is a schematic representation of an exemplary structure 2000 according to an embodiment with two integrated sensors 2100 and 2200, which is configured to synchronize reading of sensor data. The sensors 2100 and 2200 may, for example, correspond to the inertial measurement unit and the magnetometer in FIG. 1. The sensors 2100 and 2200 are formed on a substrate 2300 and/or integrated into a mold 2400. The structure 2000 may be a single-chip system or a wafer-level chip-scale package.

The system described with reference to FIGS. 1 and 2 is described, without loss of generality, as a system in which a magnetometer 1200 or 2200 is connected to an inertial measurement unit (IMU) 1100 or 2100. However, the same principles also apply to other systems according to the present invention with other combinations of sensors.

In the example, sensor data from three sensors can be fused in the inertial measurement unit 1100 or 2100. For example, a so-called game rotation vector, i.e., information about alignment and movement in space, may be generated from acceleration data, rotation rate data and sensor data from the magnetometer 1200 or 2200 and forwarded as spatial position and orientation data to a host. This processing may also take place in other systems outside the inertial measurement unit 1100 or 2100, for example in the host 1300. Depending on the computing capacity, when processing in the inertial measurement unit 1100 or 2100, the sensor data may be processed directly and may also not be read block by block.

Sensor data may be acquired in the form of individual samples by a sensor. The sensor acquires the samples at a frequency. This sampling rate, also referred to as output data rate (ODR), may be determined by the clock generator. The sampling rate may be generated by an oscillator. The frequency of the oscillator may be in a fixed ratio to the sampling rate and/or output data rate. In an example, a counter may count from 1 to a threshold value N in each oscillator cycle. When the threshold value is reached, a new cycle may be started in the sensor and the counter may be reset, for example to 0.

Due to inaccuracies of the oscillator, for example due to temperature variation, tolerances and/or deviations in production, natural degradation in the course of aging and/or operating time, etc., the actual sampling rate may regularly be in the range between +/−5% or even +/−10% of a specified sampling rate.

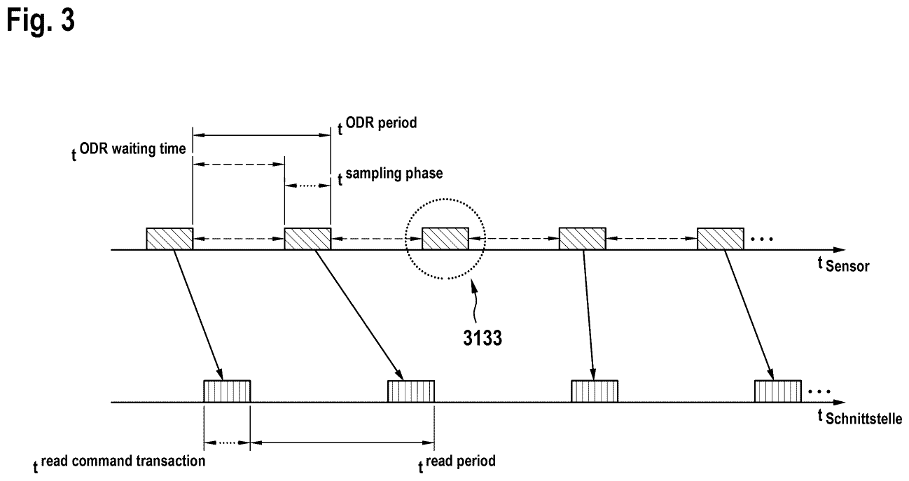

As shown with reference to FIG. 3, a sample 3133 of an unsynchronized sensor (cf. FIG. 3 above), which has been acquired at an actual sampling rate during a sampling phase t^{sampling phase}, may be lost when reading the sensor data, because the sample 3133 was skipped when the sensor data were assigned to a read command transaction t^{read command transaction} of the interface (cf. FIG. 3 below). It is therefore desirable to synchronize the actual sampling rate and the specified sampling rate in order, for example, to make reading of the sensor data possible without data loss.

In order to synchronize the actual sampling rate and the specified sampling rate, a first subsystem, for example the sensor 1100 in FIG. 1, in a conventional system may transmit synchronization messages to a second subsystem, for example the sensor 1200 in FIG. 1, in regular succession. A time elapsed between two synchronization messages is then determined by means of the mentioned counter, or by means of another counter running at a fixed ratio, and, based thereon, a threshold value N is ascertained and set by, for example, the mentioned counter. When the threshold value is exceeded, the time has come to provide new data to the first subsystem.

According to an embodiment of the present invention, the synchronization can be carried out without and/or not solely with synchronization messages, but on the basis or at least partially on the basis of the read command transactions that are required anyway, via the interface between the first and the second subsystem. A time t^{readperiod} elapsed between two read command transactions is determined by means of the mentioned counter, or by means of another counter running at a fixed ratio, and, based thereon, a threshold value N is ascertained and set by, for example, the mentioned counter. When the threshold value is exceeded, the time has come to provide new data to the first subsystem.

In other words, the second subsystem must provide data when the first subsystem wants to read data. The second subsystem uses its own clock generator to predict the time of the next read access and accordingly starts internal processes in due time, which lead to data registers that are filled in due time.

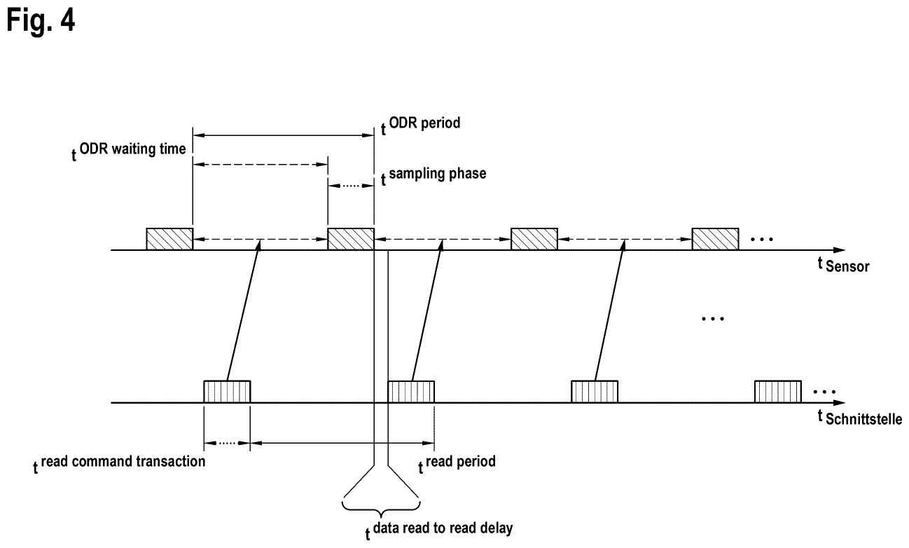

FIG. 4 is a schematic representation of an exemplary synchronized process of reading sensor data via an interface according to an embodiment.

The read period t^{read period} of the interface that has been ascertained by the sensor (cf. FIG. 4 above) and has elapsed between two read command transactions t^{read command transaction} is used to determine and adjust a waiting time t^{ODR waiting time} between the end of a preceding sampling phase t^{sampling phase} and the start of a directly subsequent sampling phase t^{sampling phase}, so that the sensor is running synchronously with the read command transactions t^{read command transaction}. The waiting time t^{ODR waiting time} between the end of a preceding sampling phase t^{sampling phase} and the start of a directly subsequent sampling phase t^{sampling phase} can essentially be determined according to the following relationship:

$${t}^{ODR waiting time} = {t}^{read period} - {t}^{sampling phase}$$

In the example shown in FIG. 4, the sensor operates in duty cycles, i.e., the sensor is not operated continuously, but is only active during a portion of a time elapsed between two acquisition phases, in a sampling period t^{ODR period} of the sensor.

For example, in order to improve the real-time capability of the system, simultaneously with determining and setting t^{ODR waiting time} according to the above relationship, a sample to be acquired can be started at the latest possible time in the sampling period t^{ODR period} of the sensor, so that the data acquired from the interface are as new as possible. In other words, a time t^{data read to read delay} between filling a data register in the sensor and reading the sensor data via the interface can be minimized so that essentially t^{data read to read delay}=0. Preferably, however, t^{data read to read delay} may be slightly greater than 0, so that, for example, possible fluctuations in the sampling and read command rates can be absorbed.

The read command transactions t^{read command transaction} of the interface should preferably be carried out synchronously, in particular without jitter, i.e., without any fluctuations in the clock speed or the frequency. The read command transactions may preferably not be generated in a microcontroller, but preferably directly in hardware of the system, e.g., an application-specific integrated circuit (ASIC) in which an execution time of an instruction can be precisely defined.

Alternatively or additionally, an average value (t^{read period}) of the differences between the last n read command transactions may also be used to determine the waiting time t^{ODR waiting time} between the end of a preceding sampling phase t^{sampling phase} and the start of a directly subsequent sampling phase t^{sampling phase}, t^{ODR waiting time}= [symbol] t^{read period} [symbol] −t^{sampling phase}. On the side of the sensor to be synchronized, the required adjustment of a counter may, for example, be ascertained from the time difference between two consecutive read command transactions and/or the average value of the last n read command transactions.

An IIR low-pass filter (infinite impulse response, IIR) or an FIR low-pass filter (finite impulse response, FIR) may be used to compensate for fluctuations in the read period t^{read period}. The use of IIR and/or FIR low-pass filters can be carried out in a technically simple and cost-effective manner.

The low-pass filter may preferably have a cutoff frequency of 5 Hz or less in order to compensate for fluctuations in the read period t^{read period}. In order to be able to follow rapid temperature changes and to achieve accuracy of the read period t^{read period} of about 0.1%, the cutoff frequency may be 0.2 Hz or less. In one example, a fluctuation in the read period t^{read period} may be 20% at 120 K, or 0.17% per Kelvin. With a maximum temperature change of 5 K per second, this results in a fluctuation of 0.85% per second. If the desired accuracy is 0.1 to 0.5%, the cutoff frequency should be 1.7 to 8.5 Hz.

The waiting time t^{ODR waiting time} between the end of a preceding sampling phase t^{sampling phase} and the start of a directly subsequent sampling phase t^{sampling phase} can therefore be essentially determined according to the following relationship by including t^{data read to read delay}.

$${t}^{ODR waiting time} = {t}^{read period} - {t}^{sampling phase} + Δ {t}^{data read to read delay} ,$$

where Δt^{data read to read delay} is the difference between an actual value of the time period between the end of the sampling phase t^{sampling phase} and the beginning of the read command transaction t^{read command transaction} and denotes a desired value of this time period.

In alternative or additional examples, further adjustments may be possible or further aspects may be taken into account. For example, the waiting time t^{ODR waiting time} between the end of a preceding sampling phase t^{sampling phase} and the start of a directly subsequent sampling phase t^{sampling phase} may not be negative. By limiting a maximum possible adjustment per sampling period t^{ODR period} and/or through the low-pass filtering described above, an initial synchronization, which may, for example, be carried out after the system has been switched on, may in particular last a plurality of sampling periods.

As an alternative or in addition to adjusting a counter of a subsystem, a clock generator of the subsystem may also be adjusted in order to realize the synchronization described above. An adjustment of the clock generator may lead to all processes that are clocked in the subsystem and/or a coupled system by the clock generator being corrected in the same way. This makes it possible to operate the subsystem at an increased clock speed, for example if the subsystem is configured to operate at a maximum (or minimum) of 400 Hz, but the subsystem is designed to operate the subsystem at, for example, 440 Hz (360 Hz), as required via an interface, for example. A corresponding positive (negative) acceleration of the clock generator of the subsystem may make it possible to operate the subsystem at, for example, 440 Hz (360 Hz).

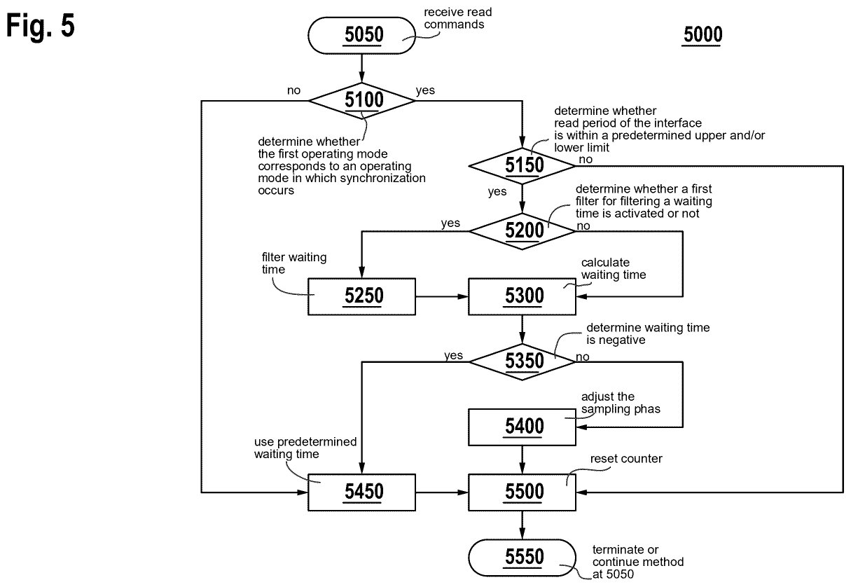

FIG. 5 is a schematic representation of an exemplary method 5000 for synchronizing reading of sensor data via an interface according to an embodiment.

The method 5000 comprises receiving 5050, in a second subsystem of a system, a plurality of read command transactions via an interface between a first subsystem and the second subsystem of the system, wherein the second subsystem is configured to synchronize the first subsystem and the second subsystem based on the plurality of read command transactions.

Receiving 5050 the plurality of read command transactions may be carried out in a first operating mode of the second subsystem. The method may comprise determining 5100 whether the first operating mode corresponds to an operating mode in which synchronization of the first subsystem and the second subsystem is activated or not.

The method may comprise determining 5150, based on the plurality of read command transactions, whether a read period t^{read period} of the interface is within a range with a predetermined upper limit and/or a predetermined lower limit. Determining 5150 may be carried out in response to a determination that the first operating mode corresponds to an operating mode in which the synchronization of the first subsystem and the second subsystem is activated.

The method may comprise determining 5200, based on the plurality of read command transactions, whether a filter for filtering 5250 a waiting time t^{ODR waiting time} between an end of a first sampling phase t^{sampling phase} and a start of a second, directly subsequent sampling phase t^{sampling phase} is activated or not. Determining 5200 may be carried out in response to a determination that the read period t^{read period} of the interface is within a range with the predetermined upper limit and/or the predetermined lower limit.

The method may comprise filtering 5250 the waiting time t^{ODR waiting time}.

The method comprises calculating 5300 the waiting time t^{ODR waiting time} between the end of a first sampling phase t^{sampling phase} and the start of a second, directly subsequent sampling phase t^{sampling phase} based on the plurality of read command transactions. Calculating 5300 may comprise calculating an average value of the read period t^{read period} based on the plurality of read command transactions. Calculating 5300 may be carried out in response to a determination that the filter for filtering 5250 is not activated. Calculating 5300 may be carried out in response to a determination that the read period t^{read period} of the interface is not within a range with the predetermined upper limit and/or the predetermined lower limit.

The method may comprise determining 5350 that the waiting time t^{ODR waiting time} is negative.

The method may comprise adjusting 5400 the sampling phase t^{sampling phase}. Adjusting 5400 may be carried out in response to a determination that the waiting time t^{ODR waiting time} is not negative.

The method may comprise using 5450 a predetermined waiting time t^{ODR waiting time}. Using 5450 the predetermined waiting time t t^{ODR waiting time} may be carried out in response to a determination that the first operating mode corresponds to an operating mode in which the synchronization of the first subsystem and the second subsystem is not activated. Using 5450 the predetermined waiting time t^{ODR waiting time} may also be carried out in response to a determination that the waiting time t^{ODR waiting time} is negative.

The method comprises resetting 5500 a counter configured to count from 1 to a threshold value N during a sampling period t^{ODR period}. Resetting 5500 may be carried out using the calculated waiting time t^{ODR waiting time} or using 5450 the predetermined waiting time t^{ODR waiting time}.

The method may comprise terminating 5550 or continuing the method (step 5050) of the method.

1-10. (canceled)

11. A method for synchronizing a system using read command transactions, the method comprising the following steps:
receiving, in a second subsystem of the system, a plurality of read command transactions via an interface between a first subsystem and the second subsystem of the system, wherein the second subsystem is configured to synchronize the first subsystem and the second subsystem based on the plurality of read command transactions.

12. The method according to claim 11, the method further comprising:
determining a read period of the interface that has elapsed between two of the read command transactions, to calculate a waiting time between an end of a sampling phase and a start of a directly subsequent sampling phase of the second subsystem.

13. The method according to claim 11, further comprising:
determining an average value of a plurality of read periods of the interface that have elapsed between two of the read command transactions, to calculate a waiting time between an end of a sampling phase and a start of a directly subsequent sampling phase of the second subsystem.

14. The method according to claim 12, further comprising:
resetting a counter configured to count from 1 to a threshold value N until a sampling period expires, so that the waiting time corresponds to a difference between the read period and the sampling phase.

15. The method according to claim 13, further comprising:
resetting a counter configured to count from 1 to a threshold value N until a sampling period expires, so that the waiting time corresponds to a difference between an average value of the read period and the sampling phase.

16. The method according to claim 11, further comprising:
adjusting a clock generator of the second subsystem based on the plurality of read command transactions.

17. The method according to claim 11, further comprising:
adjusting a time between an expiration of the sampling phase and a beginning of a next read command transaction.

18. A system, comprising:
an arrangement configured to receive, in a second subsystem of the system, a plurality of read command transactions via an interface between a first subsystem and the second subsystem of the system, wherein the second subsystem is configured to synchronize the first subsystem and the second subsystem based on the plurality of read command transactions.

19. The system according to claim 18, further comprising:
an arrangement configured to determine a read period of the interface that has elapsed between two of the read command transactions, to calculate a waiting time between an end of a sampling phase and a start of a directly subsequent sampling phase of the second subsystem.

20. The system according to claim 18, wherein the first subsystem is a sensor, which includes an inertial measurement unit, and the second subsystem is a sensor which includes a magnetometer.
